(19) United States
(12) Patent Application Publication
(10) Pub. No.: US 2009/0191363 A1
(43) Pub. Date: Jul. 30, 2009

(54) Durable, collapsible information sheet

(76) Inventor: Max Edward, Santa Cruz, CA (US)

Correspondence Address: MAX E. MONTGOMERY, 322 ALTA AVE., SANTA CRUZ, CA, 95060, US

(21) Appl. No.: 12/011,264

(22) Filed: Jan. 28, 2008

(51) Int. Cl. B32B 1/04

(52) U.S. Cl. 428/12

(57) ABSTRACT

Enclosed herein is a design and method for creating a durable, compact, collapsible information sheet. This is accomplished by creating a collapsible information sheet comprised of a single elongated loop of a thin strip of spring-like material covered by one or more sheets of flexible covering material. The flexible covering material is comprised of one or more thin layers of fabric, or a synthetic high-density polyethylene fiber, or an alternate material that is durable, light, flexible, preprinted or suitable for printing. The information sheet shape is largely rectangular with slightly rounded corners. The information sheet size is determined by the loop dimension of the spring-like material and the printable covering material encasing the loop created by the spring-like material. The single elongated fabric-covered loop of the information sheet is easily twisted and folded into a compact configuration consisting of a series of smaller concentric loops and covering material layers. The collapsible information sheet may additionally comprise a means for maintaining the compact configuration for storage, such as Velcro closures, snaps or other means later described or obvious to those skilled in the art. When closed, the information sheet is easily opened by twisting the elongated fabric-covered loop of the information sheet. The collapsible information sheet may also comprise one or more removable or fixed accessories such as, but not limited to, a compass or a light to further increase the utility of the information sheet. The collapsible information sheet may also comprise one or more smaller collapsible information sheets that may be temporarily affixed to the perimeter of the larger information sheet.

### CROSS REFERENCE TO RELATED APPLICATIONS

This application claims the benefit of provisional patent application Ser. No. 60/897,359 filed on Jan. 24, 2007.

### BACKGROUND

1. Field of Invention

This invention relates to collapsible information sheets, such as maps, specifically to improved methods and materials for creating increasingly durable information sheets with an enhanced compact form that is fast and easy to open and close.

2. Description of Prior Art

Information sheets, such as maps, are traditionally printed on one or both sides of a piece of paper and then folded in a rectangular manner to reduce the form factor.

In addition to the rectangular folding scheme well known to all familiar with the art, there is a large body of prior art dealing with alternate folding mechanisms for printed information sheets. This includes art such as and similar to Lein's Foldable Sheet (U.S. Pat. No. 4,906,024—March 1990), Knoor's Map (U.S. Pat. No. 5,217,257—June 1993), Perttunen's Foldable Article (U.S. Pat. No. 5,928,753—July 1999 and 5,882,763—March 1999), Crum's Promotional Booklet (U.S. Pat. No. 5,725,252—1998), Huber's Fold Pattern (U.S. Pat. No. 6,354,985 B2—March 2002), and Twardosz' Information Sheet and a Method For It's Folding (U.S. Pat. No. 6,158,777—December 2000). All such art is based on time-consuming, linear or angular folding techniques.

There is a wide body of art that details reducing the size of information sheets, such as maps, using an accordion fold mechanism, such as McDonald's Folded Sheet Articles (U.S. Pat. No. 5,156,898—October 1992, U.S. Pat. No. 5,538,761—October 1994, U.S. Pat. No. 5,360,655—November 1994, U.S. Pat. RE 36,395—November 1999) and Judson's Magnetically Closed Foldable Map (US Patent 2005/0285384—December 2005). Further art detailing methods in which to print and effectively page through large quantities of information includes Bergstresser's Foldout Information Book and Method for Making The Same (U.S. Pat. No. 6,045,158—April 2000), Donley's Method of Folding (U.S. Pat. No. 6,056,321—May 2000), Felderman's Technique for Reducing a Large Map Into a Compact Paging Format (U.S. Pat. No. 6,189,933 B1—February 2001), and Exline's Wallet Size Pocketed Booklet (U.S. Pat. No. 6,120,228—September 2000). This also focuses on traditional foldable informational sheets.

Other art, such as Muth's Sheet Folding Method and Apparatus (U.S. Pat. No. 4,502,711—March 1985, U.S. Pat. No. 4,917,405—April 1990), describe folding patterns that create information sheets in a pop up form or with pop up elements like those found in a children's book. Further art describe alternate pop out forms for printed sheets. This includes art such as and similar to Nickerson's Map Construction (U.S. Pat. No. 4,606,553—April 1986), Markovics' Album With Foldable Sheets (U.S. Pat. No. 4,627,640—December 1986), Eller's Fine Jeweler Enclosing Wearer Identification and Medical Information Therein (U.S. Pat. No. 4,984,683—January 1991), and Bigler's Folding Apparatus (U.S. Pat. No. 5,794,980—August 1998). These linear or angular folding form factors are not durable for outside use, especially in inclement weather.

Weather-resistant information sheets are addressed by a wide body of art focusing on alternate material, or material coverings in the standard page, folded or booklet format. Such art includes Hayne's Laminated Folding Map (U.S. Pat. No. 5,207,457—May 1993), Brown's Flip Flop Float Chart (U.S. Pat. No. 5,466,009—November 1995) which included a unique folding shape and lamination, Hull's Navigator Display Plotter and Method of Use (U.S. Pat. No. 5,647,156—July 1997), Tunnel's Weather Resistant Mapboard Assembly (U.S. Pat. No. 5,732,978—March 1998), Raymond's Multidirectional Multiple Fold Laminated Product and Method of Making (U.S. Pat. No. 5,868,429—February 1999). McDonald's Method and Apparatus for Laminating Stiffeners With Folded Sheets (U.S. Pat. No. 6,007,895—December 1999), and Berndtson's Laminated Country Map or Road Map (U.S. Pat. No. 6,516,547 B2—February 2003) which describes a map laminated with some type of PET film. These methods focus primarily on traditional shapes or folding patterns.

Non-rectangular shapes are well known in the body of information sheets or map art, some of which have been previously listed. There is a body of prior art addressing circular map shapes and accessories or features to aid in navigation. This body includes Hamm's Navigational Charting and Calculating Device (U.S. Pat. No. 3,983,630—October 1976), Powell's Dual Stereographic Net (U.S. Pat. No. 4,152,835—May 1979), Fowler's Street Address Locating Aid (U.S. Pat. No. 4,176,860—December 1979) and other art similar to it. All of this art deals with standard non-collapsible rigid materials or those using traditional folding methods.

Other art introduces information sheet accessories. Dacey's Map (US Patent 2004/0130140—July 2004) claims a map with a compass housing and flange. Prieschl's Navigation Device (US Patent 2004/0130140—July 2004) details a compass module into which a map is placed to help orient the user to features on the map. Both of these are limited as they are visible only one surface.

There is a wide body of non-information sheet prior art using an alternate compact folding mechanism and shape. Kasier's Beach Blanket (U.S. Pat. No. 4,951,333—August 1990) details a collapsible beach blanket with a removable hoop. Huang's Compactly Foldable Automobile Sunshade (U.S. Pat. No. 5,204,262—June 1991) details a collapsible screen to block the sun in a parked car. Zheng's Collapsible Play Structures (U.S. Pat. No. 5,560,385—October 1996) and Zheng's Collapsible Shade Structure (U.S. Pat. No. 5,467,794—November 1995) introduces a series of foldable frame members attached to each other to create a tent-like structure. Maines' Temporary Brattice For Mines (U.S. Pat. No. 5,683,294—November 1997) details using one or more collapsible sheets as a fire block in a mine shaft. Zheng's Collapsible Assembly (U.S. Pat. No. 6,073,283—Jun. 13, 2000 and U.S. Pat. No. 6,408,461 B2—June 2002) detail a collapsible mat with a removable layer that may be used independently from the mat as a blanket or remain as part of the mat. Le Gette's Collapsible Mat with Removable Portion and Method of Making Same (U.S. Pat. No. 6,691,344 B2—February 2004). Some of this non-information sheet prior art, when put into practice, includes printed patterns, branded characters, corporate logos, and even pictorial scenes, yet all are design elements on the object, none are printed or used for mapping, navigational or detailed informational purposes.

Wearable information sheets, such as maps for outdoor activities such as skiing, are presented by Bissonnette's Detachable Ski or Terrain Map (U.S. Pat. No. 4,957,310—September 1990) and Seawright's Wearable Folded Map (U.S. Pat. No. 6,644,694 B2—November 2003). These traditional foldable implementations are neither convenient nor durable.

Maps in a scroll format are well known. Examples of such prior art include R. J. Richey's Road Map Holder (U.S. Pat. No. 1,583,998—May 1926), James' Drawing Case for Architects and the Like (U.S. Pat. No. 3,884,351—May 1975), and Metzler's Map Holder (U.S. Pat. No. 5,390,957—February 1995). Ehsanipour's Map Holding and Locating Kit (U.S. Pat. No. 4,360,346—November 1982) and Yokayama's Foldable Map with Present Location Indicator and Paper Reinforcing (U.S. Pat. No. 4,477,254—October 1984) introduce location indicators.

The prior art listed reflects the state of the art of which the applicant is aware. None of these references teach singly nor render obvious when considered in any combination the invention as disclosed in greater detail and as later claimed.

The key problem with the prior art is that it:
Creates collapsible information sheets that are hard to refold, leading to wear and tear, decreasing both the utility of the information sheet and user satisfaction, which also leads to waste.
Doesn't provide a quick and easy method to open and close collapsible information sheets.
Doesn't provide a convenient form for collapsible information sheets for outdoor use, such as ski maps, trail maps, or amusement park maps.
Doesn't provide a durable form for collapsible information sheets for outdoor use, such as ski maps, trail maps, or amusement park maps.

### OBJECTS AND ADVANTAGES

Accordingly, these problems are overcome with the present invention. A durable, compact, collapsible information sheet is comprised of a single elongated loop of a thin strip of spring-like material covered by one or more sheets of flexible covering material. The flexible covering material is comprised of one or more thin layers of fabric, or a synthetic high-density polyethylene fiber, or an alternate material that is durable, light, flexible, preprinted or suitable for printing. The information sheet shape is largely rectangular with slightly rounded corners. The information sheet size is determined by the loop dimension of the spring-like material and the printable covering material encasing the loop created by the spring-like material. The single elongated fabric-covered loop of the information sheet is quickly and easily twisted and folded into a compact configuration consisting of a series of smaller concentric loops and covering material layers. The collapsible information sheet may additionally comprise a means for maintaining the compact configuration for storage, such as Velcro closures, snaps or other means later described or obvious to those skilled in the art. When closed, the information sheet is quickly and easily opened by twisting the elongated fabric-covered loop of the information sheet. The collapsible information sheet may also comprise one or more removable or fixed accessories such as, but not limited to, a light or a compass to further increase the utility of the information sheet. Additionally, one or more smaller collapsible information sheets may be temporarily affixed to the perimeter of the larger information sheet.

Many advantages are created with such a collapsible informational sheet:
The simplicity and speed in which the information sheet is fully opened and fully closed is one core advantage over prior art. The user does not have to navigate a complex series of folds when opening the information sheet nor to remember to reverse those steps to successfully close the information sheet. It takes but a simple twist of the wrists to fully open or fully close a collapsible information sheet using this design. The act of opening and closing such a collapsible information sheet is well known to most, and it is easily learned by those that do not. This makes such information sheets ideal for any use, particularly applications such as skiing, camping or sightseeing maps.
Collapsible information sheets can be made out of thin, durable, flexible, waterproof and tearproof materials such as Tyvek, or any alternate material with similar or improved properties. A collapsible information sheet constructed of such material is ideal for any type of weather, particularly in the outdoors. This creates ideal collapsible information sheets, such as maps, for outdoor enthusiasts, such as, but not limited to: hikers, boaters, skiers, kayakers, mountain climbers, and bicycle riders. Even underwater information sheets or maps for scuba diving are possible.
Collapsible information sheets are compact in size when closed. They can be easily stored or put in the pocket of a jacket, backpack, glove box, automobile console, window visor, as well as any sleeve, or special enclosure designed specifically to hold them. This is particularly useful for those engaging in outdoor activities.
People are less likely to throw away a durable item, hence the durability and novelty of such collapsible information sheets also makes them ideal for maps for amusement parks, museums, trade shows, conferences, and other entertainment locations as the collapsible information sheet serves also as a marketing tool after the user has left the target location.

Alternate embodiments, describe more in detail at the end of the specification, introduce accessories such as built in or snap on compasses, lights, compact storage mechanisms, alternate shapes, retractable scrolling information sheets, and additional utilitarian collapsible information sheet features.

### DRAWING FIGURES

FIG. 1—is a top plan view, partially broken away, of one embodiment of the present invention;

FIG. 2—is a reverse bottom plan view of the embodiment shown in FIG. 1;

FIG. 3—is a top plan view, partially broken away, of an alternate embodiment of the present invention;

FIG. 4—is a top plan view of an alternate embodiment of the present invention;

FIG. 5—is a top plan view of the embodiment shown in FIG. 1 when in partially collapsed form;

FIG. 6—is a top plan view of the embodiment shown in FIG. 1, but with a restraining loop affixed to the perimeter;

FIG. 7—is a top plan perspective view of the embodiment shown in FIG. 1, but with an illuminated compass affixed to the perimeter;

FIG. 8—is a top plan perspective view of the embodiment shown in FIG. 1, but with an illuminated compass and a restraining loop affixed to the perimeter;

FIG. 9—is a top plan perspective view of the embodiment shown in FIG. 8, but with an illuminated compass affixed to the body of the material covering;

FIG. 10—is a top plan view of one embodiment of the illuminated compass show in FIG. 7, FIG. 8, and FIG. 9;

FIG. 11—is a right side cut away view of to embodiments of the illuminated compass show in FIG. 10;

FIG. 12—is a top plan view of an alternate embodiment of the present invention;

FIG. 13—is a top plan view of an alternate embodiment of the present invention;

FIG. 14—is a top plan view of an alternate embodiment of the embodiment shown in FIG. 13;

### DRAWING REFERENCE NUMBERS

2—Collapsible Information Sheet
3—Single Retractable Scroll Sheet
4—Dual Retractable Scroll Sheet
10—Spring-Like Material Loop
12—Connector
13—Pull Tab
14—Loop Encasement
15—Additional Information Layer
16—Fastening Pad
20—Covering Material Suitable for Printing
22—Enclosed Spring-Like Material Loop
24—External Covering Material
30—Flexible Restraining Loop
40—Sheet Compass and Light Accessory
42—Accessory Light Diffusers
43—Two Part Compass and Light Accessory
44—Docking Recess
45—Compass Needle
46—Light Switch
47—Top Accessory Fastener
48—Bottom Accessory Fastener
50—Sheet or Transparent Sheet Holding Material
52—Scroll Sheet Body
54—Sheet Scroll Stop
56—Sheet Scroll Twister
58—Scroll Sheet Light and Compass
60—Sheet Scroll Release

### DETAILED DESCRIPTION OF EXEMPLARY EMBODIMENT(S)

Reference numerals designate like elements throughout the drawings. For ease of illustration and description, the drawings illustrate only the pertinent features of the present invention and do not show the remaining conventional features.

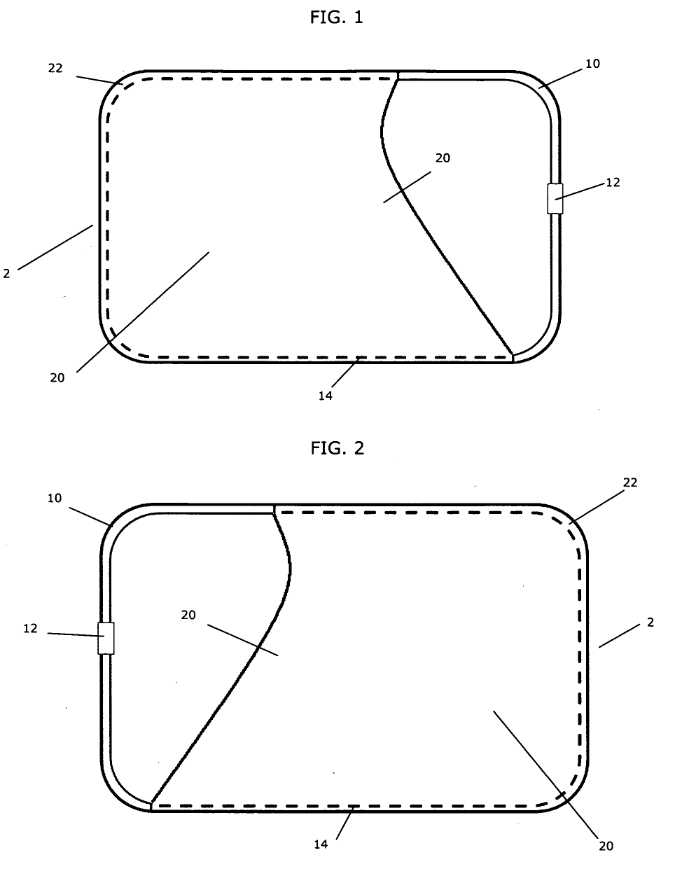

Depicted in FIG. 1 is the primary embodiment of the collapsible information sheet 2 in expanded form. In the preferred embodiment, the collapsible information sheet 2 comprises a generally rectangular sheet of covering material 20 of one or more layers of flexible material suitable for printing with a thin strip or wire of spring-like material 10 secured to the perimeter of covering material 20. The covering material 20 can be made of one or two layers of a densely woven fabric or an alternately suitable material like Tyvek. The spring-like material loop 10 can comprise a thin strip of spring steel, wire, plastic, or any other suitable material having sufficient springiness and durability.

The covering material 20 can be comprised of two pieces of material sewn, glued or affixed together in another manner. Alternately the covering material 20 can be comprised of one piece of material folded over to make in effect two layers or one piece of material not folded over to comprise one layer. If covering material 20 consists of only one layer, the spring-like material loop 10 can be secured to covering material 20 by sewing spring-like material loop 10 in a loop encasement 14 along the perimeter of covering material 20. If covering material 20 consists of two or more layers of material, the outer perimeters of the layers can be sewn together with spring-like material loop 10 contained between the layers of material outside of or in a loop encasement 14. Other ways of securing spring-like material loop 10 to covering material 20 will occur to those skilled in the art.

As shown in the broken away portion of FIG. 1, the single spring-like material loop 10 can be formed by connecting the free ends of an elongated strip of spring-like material after it has been bent into the required shape. Connector 12 can comprise a short piece of metal, the ends of which are crimped, folded over, or affixed in some other fashion to secure the free ends of spring-like material loop 10. Alternatively, a continuous loop could be fabricated by welding the ends together in the case of certain metals, or forming one continuous loop of material in the case of certain plastics or other materials.

At least one of the major surfaces of covering material 20 is printed or suitable for printing, silk screening, or an alternate method of displaying fixed information. In the preferred embodiment, the surface of the covering material 20 is printed or suitable for printing on both sides. FIG. 2 presents the reverse side of the collapsible information sheet 2 shown in FIG. 1.

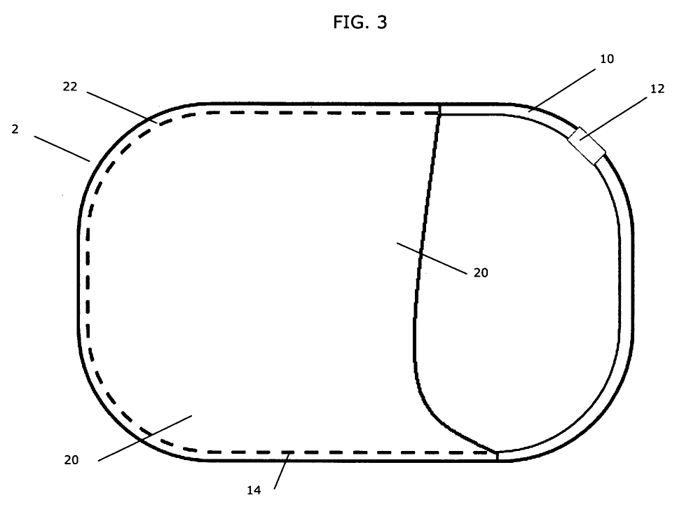

The spring-like material loop 10 which maintains the collapsible information sheet 2 in an open configuration suitable for use can have several different shapes, including but not limited to a circle, oval, rectangle, or even a heart-shape. In the preferred embodiment, the shape of the loop is generally rectangular with rounded corners. FIG. 3 details an alternate shape embodiment of a collapsible information sheet 2 with further rounded corners yet maintains the same structural components found in FIG. 1.

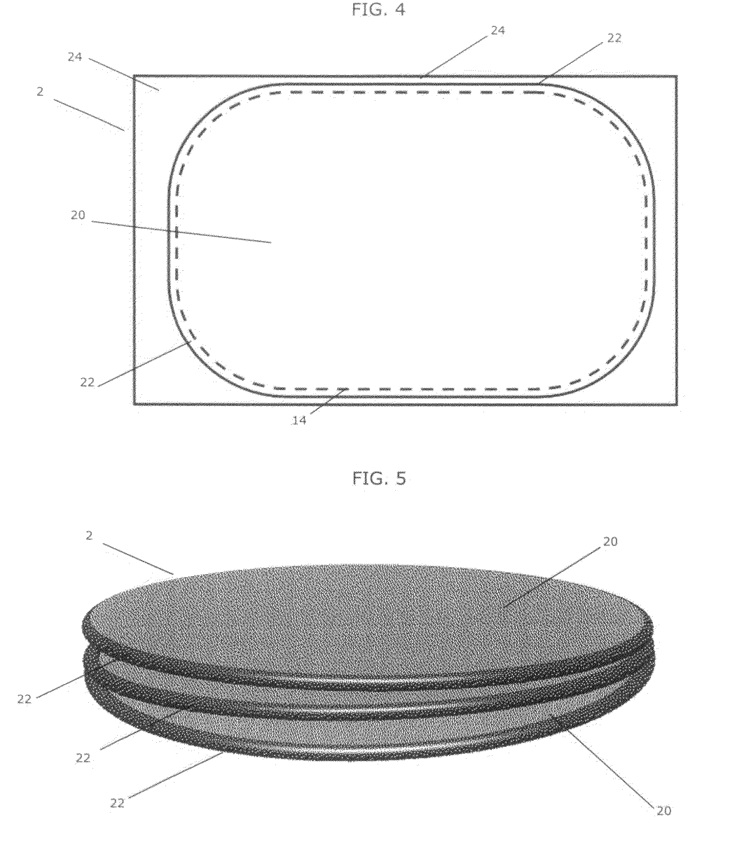

FIG. 4 shows an alternate embodiment of the collapsible information sheet 2 in which the covering material 20 extends beyond the bounds of the loop encasement 14. The material outside of this loop is referred to as external covering material 24 and may provide additional area for printing, accessory fasteners, instructions, or an alternate purpose.

FIG. 5. shows the collapsible information sheet 2 in a collapsed form. The enclosed spring-like material loop 22 coils upon itself when twisted and the collapsible information sheet 2 takes the compact form of several smaller nested circles.

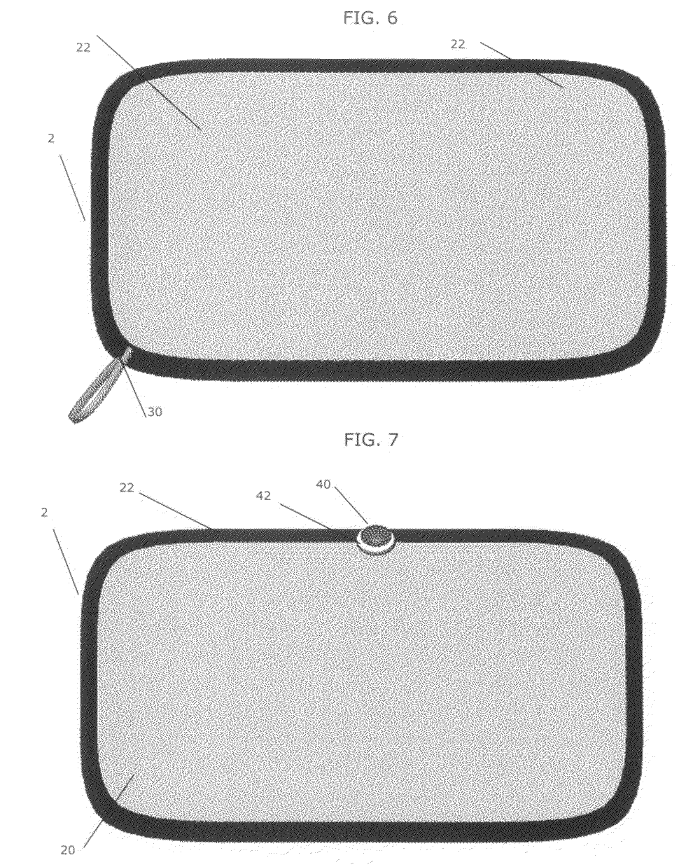

FIG. 6. shows an alternate embodiment of the collapsible information sheet 2 with a flexible restraining loop 30 affixed to the perimeter of the enclosed spring-like material loop 22. The flexible restraining loop 30 is comprised of elastic, flexible plastic or another material suitable to maintain the collapsible information sheet 2 in a compact form when collapsed as shown in FIG. 5. Alternate embodiments for maintaining the compact form when collapsed include Velcro, clips, snaps, buttons, ties, attached or built in sleeves, or another suitable restraining mechanism.

FIG. 7 depicts an alternate embodiment of the collapsible information sheet 2 with a sheet compass and light accessory 40. The accessory light diffusers 42 help spread light from a low-voltage light source such as that created by an LED or OLED light. The sheet compass and light accessory 40 is also visible from both sides of the map. In addition to providing illumination to the map in dark conditions, it also creates a utilitarian safety feature for night conditions or a signaling aid to those who have lost their way. Alternate embodiments include an independent light and compass, which may take many forms obvious to those skilled in the art. A flexible gooseneck light, a spherical compass, and a flexible perimeter light are three such examples. Alternate accessory items may also provide additional utility to the information sheet, such as, but not limited to a pen, pencil or market holder, flashlight holder, thermometer, altimeter, clock, or one of many other items suitable for the application or information sheet.

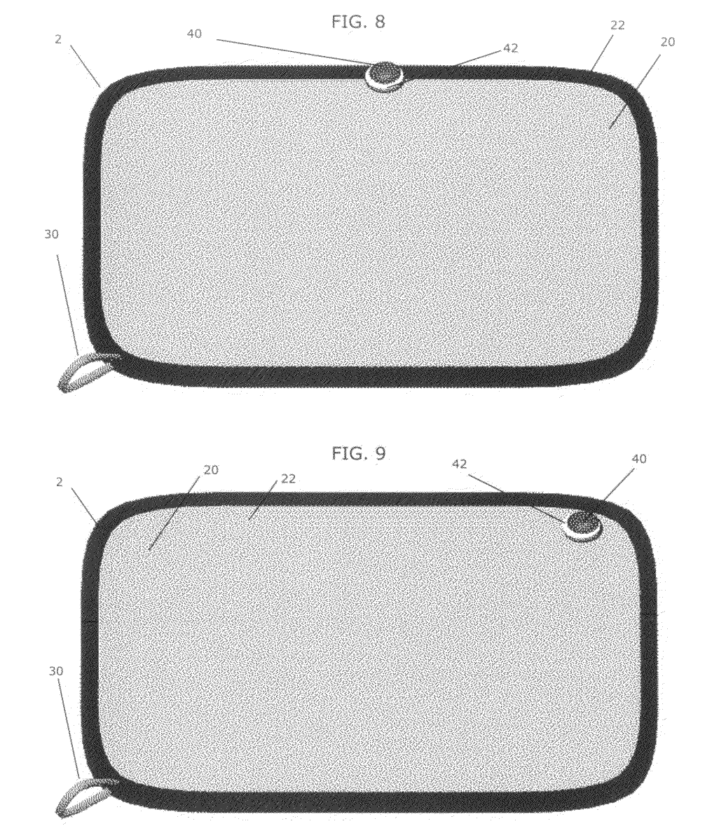

FIG. 8 depicts an alternate embodiment of the collapsible information sheet 2 in which a sheet compass and light accessory 40 and a flexible restraining loop 30 affixed to the perimeter of the enclosed spring-like material loop 22. In this embodiment, the sheet compass and light accessory 40 is affixed to the center of the enclosed spring-like material loop 22. The sheet compass and light accessory 40 may be permanently affixed with glue, rivets, stitching, molding, or some other means of attachment. Or sheet compass and light accessory 40 may be attached in a removable form via Velcro, tension, snap, socket, or some other temporary mechanism. In some of those embodiments, the sheet compass and light accessory 40 may be moved or adjusted as needed.

FIG. 9 depicts an alternate embodiment of the collapsible information sheet 2 in which a sheet compass and light accessory 40 and a flexible restraining loop 30. In this embodiment, the sheet compass and light accessory 40 is affixed to the right corner of the covering material 20. Based on the method used to affix it to the covering material 20, it may be fixed or removable.

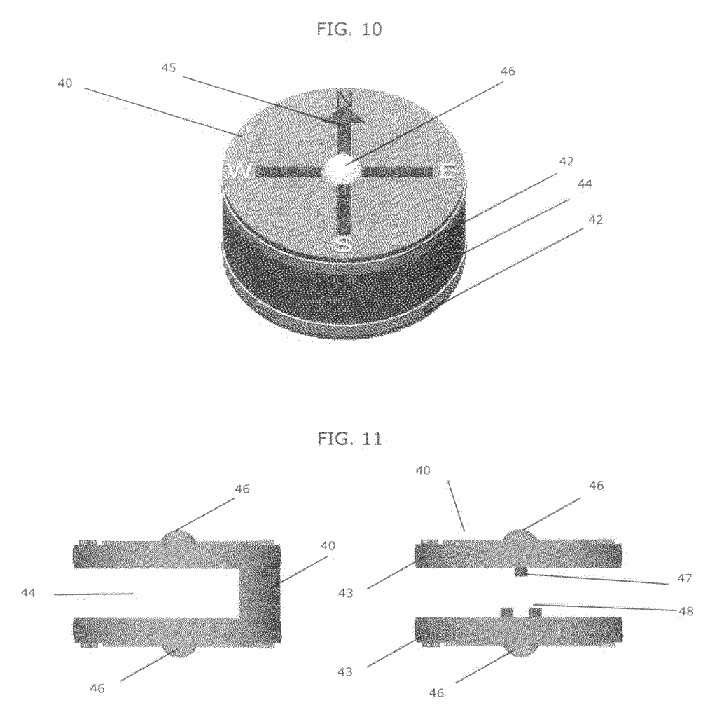

FIG. 10 depicts one embodiment of a sheet compass and light accessory 40 in further detail. The accessory contains a magnetically polarized compass needle 45 to aid in sheet orientation. A low voltage light is enclosed in the body of the sheet compass and light accessory 40. The light is turned on via a light switch 46. Light illuminates the sheet via two light diffusers 42 which protrude from the body of the sheet compass and light accessory 40. The electronics for the light are omitted and easily created by anyone skilled in the art. The body of the sheet compass and light accessory 40 has a docking recess 44 to fit onto the enclosed spring-like material loop 22 of a collapsible information sheet 2. Many alternate compass, light, and compass light accessory 40 embodiments are possible and obvious to those skilled in the art, including an independent light and compass, a flexible gooseneck light, a spherical compass, and a perimeter light, to list several such forms.

FIG. 11 depicts two embodiments of a sheet compass and light accessory 40 in further detail. The side view of the embodiment on the left more clearly presents the docking recess 44 used to fit onto the enclosed spring-like material loop 22 of a collapsible information sheet 2. The side view of the embodiment on the right introduces a two part compass and light accessory 43 in which the two parts snap together via top accessory fastener 47 and bottom accessory fastener 48. Many alternate permanent and removable fastening mechanisms are possible.

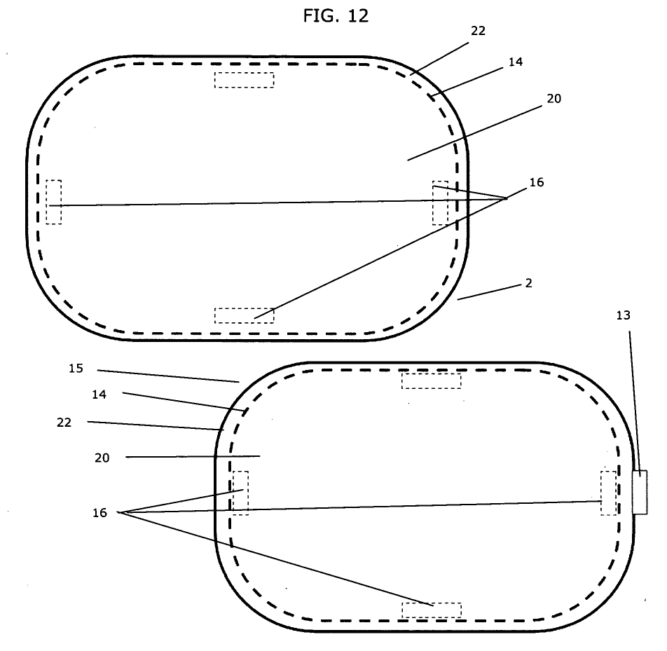

FIG. 12 depicts an alternate embodiment of a collapsible information sheet 2 in expanded form with an additional information layer 15 which is identical in construction to a standard collapsible information sheet 2 except that it is smaller in size and fits inside of the collapsible information sheet 2 via a series of fastening pads 16. A pull tab 13 may be affixed to the material of the loop encasement 14 on the additional information layer 15 to assist in separating the additional information layer 15 from the collapsible information sheet 2. The fastening pads 16 may be fashioned of Velcro, snaps, or an alternate material. Alternately the function of the fastening pads 16 may take another form that provides the same temporary fastening mechanism. In an alternate embodiment additional information layers 15 may be put onto each other in the manner described to create multiple nested additional information layers 15. This could be used to increase the amount of information easily accessible and increase the breadth of the types of applications covered by such a collapsible information sheet 2.

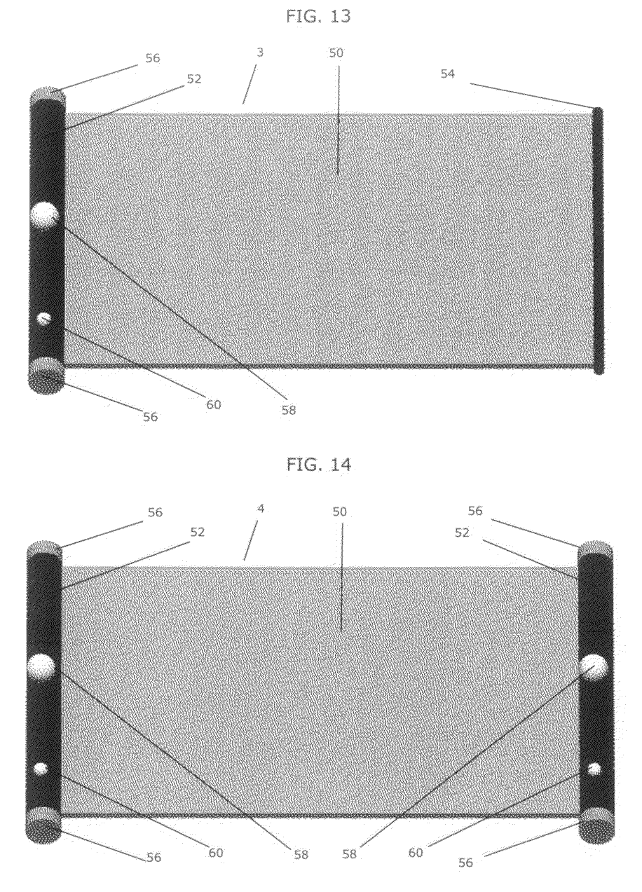

FIG. 13 depicts an alternate embodiment of a collapsible information sheet in the form of a single retractable scroll sheet 3. A sheet or transparent sheet holding material 50 in which to place an information sheet would be housed in a retractable scroll sheet body 52. One edge of the sheet or transparent sheet holding material 50 is affixed to a vertical axis found inside retractable scroll sheet body 52. The opposite edge the sheet or transparent sheet holding material 50 is affixed to a sheet scroll stop 54. An automatic tension spring or manual winding mechanism is used to retract the sheet into the retractable scroll sheet body 52 around the interior of its vertical axis.

The retractable scroll sheet body 52 also houses a sheet scroll release 60, which disengages the automatic locking mechanism, which stops the spring loaded vertical axis from turning and thus stops the sheet from unrolling or winding back onto the vertical axis. It would, by default, be locked and require constant pressure to unlock the mechanism and allow the sheet to be retracted, automatically or manually, around the vertical axis inside the scroll body. It would be possible to pull out the sheet with out having to disengage the sheet scroll release 60.

If used as a map holder, the material comprising the map holder would need to be transparent. Any printed scroll map may be constructed of materials such as paper, or Tyvek, or any alternate material suitable for printing and the durability required for the specific application.

If used as a scroll map, any printed scroll sheet would contain traditional map coordinates on the top and side edge. Alternately, the side edge of the retractable scroll sheet body 52 may contain one set of the map coordinates. The outside of the retractable scroll sheet body 52 may also be printed with the traditional horizontal and vertical coordinates of specific areas of interest, such as, but not limited to, common tourist landmarks in a city map. The sheet may provide sheet scroll twisters 56 used to wind the sheet around its vertical axis inside the retractable scroll body 52. Alternately, the retractable scroll sheet body 52 may also house a rotatable view window activated by sheet scroll twisters 56 or some other mechanism, such as a view slider, to locate a particular area of interest or other coordinates of interest from an index on a specific map. This would enable the user to more expediently locate the spot on the map. The retractable scroll sheet body 52 may also house a scroll sheet light and compass 58 to illuminate the sheet or provide an alternate light source during nighttime activities. Many alternate embodiments are possible for the accessories described in addition, but not limited to, additional accessory items such as a pen, pencil or market holder, flashlight holder, thermometer, altimeter, clock, or one of many other objects suitable for the application. The retractable scroll body 52 could alternately contain restraining straps, Velcro or another mechanism to enable a user to wear the map on their arm, for example.

FIG. 14 depicts an alternate embodiment of a collapsible information sheet in the form of a dual retractable scroll sheet 4. It consists of two retractable scroll bodies 52. Each retractable scroll body 52 is affixed to an opposite side of the same sheet or sheet holder. The benefit to this configuration is that a wide or tall sheet may be presented in such a manner. The excess sheet from retractable scroll body 52 may be taken up by the retractable scroll body 52 opposite it.

### Alternative Embodiments

Many alternate embodiments are possible, including:

The spring-like material may be encased in a presealed or enclosed loop of material which is then affixed to a flexible covering material.

A blank collapsible information sheet comprised of a material suitable for dry-erase pens, grease pencils, or other similar non-permanent marking devices would enable a pop-up white board suitable for traveling, quick set up or outdoor use. Such a sheet may, but not necessarily, have one or more fixed or removable grommets, suction cups, hooks, or similar mechanisms on it, to affix the white board to a wall, stand, or other surface. Likely there would be some type of universal connector that would enable one or more of said mechanisms to be easily added and removed.

Alternate shapes including, but not limited to, an oval, circle, and triangle are possible with similar construction based on the shape of the covering material and the loop in which the spring-like material is enclosed. Even a three-dimensional shape such as a sphere is possible using one or more spring like-loops. For example, while inflatable globe maps are well known, they require air input to expand or open and the release of that air to close. This alternate embodiment would provide a more easily collapsible and expandable form.

Another alternate use for a collapsible information sheet is as a game board. Such a collapsible information sheet could be printed with the game instructions and board markings and thus used for traveling, quick set up, outdoor use or compact form factor. Such a collapsible game board may, but not necessarily, be comprised of some type of material that would allow game pieces to temporarily adhere to it.

### SUMMARY, RAMIFICATIONS AND SCOPE

This method for creating collapsible information sheets is preferable over previous methods because it creates durable information sheets that are quick and easy to open and close while maintaining a compact form factor when closed. Such durable collapsible information sheets are well suited for a wide-range of applications; they are particularly well suited for outdoor use, even in inclement weather.

While the primary description disclosed in this patent application focuses on generic information sheets or maps, the same method, materials, and form factor described herein can be applied with utilitarian benefit to any printed materials that fit on one or two sides of one or more foldable or non-foldable printed information sheets. This includes, but is not limited to, advertising brochures, promotional materials, game boards, informational brochures, product manuals, how-to guides, reference materials, posters, or any other printed information sheet that may take a similar format to those previously described.

It should also be understood that the invention in its broader aspects is not limited to the specific embodiments shown and described herein, but departures may be made within the scope of the appended claims without departing from the principles of the invention and without sacrificing its chief advantages. All such modifications and changes will make themselves apparent to those of ordinary skilled in the art and all such changes and modifications are intended to be covered by the appended claims.

I claim:

1. An information sheet comprising:
a sheet of at least one layer of a flexible first material, said sheet having front and back surfaces, with at least one of said surfaces including a material suitable for printing; and
a single closed loop of a strip of a spring-like second material secured to said sheet throughout an entire perimeter thereof;
wherein said information sheet can be (1) deployed in a first, open configuration, said singular closed loop being continuously deformable to a predetermined contour, and, (2) twisted to form at least a pair of sections, said sections being foldable in layered fashion to form a second, compact configuration for storage.

2. The information sheet of claim 1 wherein said closed loop has the general shape of a circle.

3. The information sheet of claim 1 wherein said closed loop has the general shape of a rectangle with rounded corners.

4. The information sheet of claim 1 wherein said closed loop has the general shape of two substantially identical semicircles connected by a rectangle having one side equal in length to twice the radius of said semicircles.

5. The information sheet of claim 1 where said closed loop has the general shape of an elongated oval.

6. The information sheet of claim 1 wherein said sheet is larger in area than said closed loop and has a generally rectangular shape; and wherein said closed loop is secured to said sheet at points within the perimeter of said sheet, so that parts of said sheet lie outside said closed loop.

7. The information sheet of claim 1 wherein said strip is sewn into a hem of said sheet along the perimeter thereof.

8. The information sheet of claim 1 wherein said strip of spring-like material comprises spring steel.

9. The information sheet of claim 1 wherein said strip of spring-like material comprises a metal wire.

10. The information sheet of claim 1 wherein said strip comprises a springy plastic material.

11. The information sheet of claim 1 wherein said sheet has two congruent layers sewn together along the perimeter of said sheet to contain said strip of spring-like material between said layers.

12. The information sheet of claim 1 wherein said sheet has two congruent layers glued together along the perimeter of said sheet to contain said strip of spring-like material between said layers.

13. The information sheet of claim 1 wherein said at least one surface is comprised of Tyvek or a material with comparable properties.

14. A collapsible information sheet of claim 1 having a method to affix one or more smaller collapsible information sheets inside of the perimeter of the larger collapsible information sheet.

15. The information sheet of claim 1 further comprising means for maintaining said information sheet in said compact configuration.

16. The information sheet of claim 15 wherein said means for maintaining comprises a loop of elastic material attached to said sheet near the perimeter thereof.

17. The information sheet of claim 15 wherein said means for maintaining comprises a sleeve sewn into or affixed to said sheet near the perimeter thereof.

18. The information sheet of claim 1 further comprising an affixed or removable means for illuminating said sheet.

19. The information sheet of claim 1 further comprising an affixed or removable means for providing compass navigation on said sheet.
